(19) United States
(12) Patent Application Publication
(10) Pub. No.: US 2017/0054242 A1
(43) Pub. Date: Feb. 23, 2017

(54) ELECTRICAL CONNECTOR HAVING IMPROVED CONTACTS

(71) Applicant: FOXCONN INTERCONNECT TECHNOLOGY LIMITED, Grand Cayman (KY)

(72) Inventors: TAO WANG, Kunshan (CN); ZHEN-SHENG WANG, Kunshan (CN)

(21) Appl. No.: 15/240,165

(22) Filed: Aug. 18, 2016

(30) Foreign Application Priority Data
Aug. 18, 2015 (CN) 201520618728.0

(51) Int. Cl. H01R 13/405; H01R 13/24; H01R 12/71

(52) U.S. Cl. CPC H01R 13/405; H01R 12/716; H01R 13/24

(57) ABSTRACT

An electrical connector includes an insulative housing and a number of contacts over-molded in the insulative housing, each of the contacts including: a conductive member comprising a base portion and a contact portion projected from the base portion and exposed out of the insulative housing for being electrically connected with a mating connector contact; and a connecting member electrically connected with the conductive member. The connecting member includes a soldering portion soldered with the base portion, an elastic portion for connecting to a printed circuit board, and a connecting portion connected between the soldering portion and the elastic portion.

### BACKGROUND OF THE INVENTION

1. Field of the Invention

The present invention relates to an electrical connector, and more particularly to contacts structure of the electrical connector.

2. Description of Related Arts

U.S. Pat. No. 7,901,216, issued on Mar. 8, 2011, discloses an electrical connector adapted for connecting a plug connector to a printed circuit board. The electrical connector comprises a body, a plurality of contacts, and a shell enclosing the body. The electrical connector is soldered to the printed circuit board through pins. The contacts are substantially flat plates electrically connected to the pins by wires.

U.S. Patent Application Publication No. 20150349457, published on Dec. 3, 2015, shows a port including a metal frame surrounding a well, a plurality of contact pads disposed within the well, and an insulative frame for isolating the contact pads.

### SUMMARY OF THE INVENTION

An object of the present invention is to provide an electrical connector having an improved contact structure that is electrically connected to a printed circuit board reliably.

To achieve the above-mentioned object, an electrical connector comprises: an insulative housing; and a plurality of contacts being over molded in the insulative housing, each of the contacts comprising:

a conductive member comprising a base portion and a contact portion projected from the base portion and exposed out of the insulative housing for being electrically connected with a mating connector contact; and

a connecting member electrically connected with the conductive member, the connecting member including a soldering portion soldered with the base portion, an elastic portion for connecting to a printed circuit board, and a connecting portion connected between the soldering portion and the elastic portion.

### BRIEF DESCRIPTION OF THE DRAWING

FIG. 1 is a perspective view of an electrical connector in accordance with the present invention;

FIG. 2 is another perspective view of an electrical connector as shown in FIG. 1;

FIG. 3 is a partly exploded view of the electrical connector as shown in FIG. 1;

FIG. 4 is another partly exploded view of the electrical connector as shown in FIG. 3; and

FIG. 5 is cross sectional view of the electrical connector taken along line 5-5 in FIG. 1.

### DETAILED DESCRIPTION OF THE PREFERRED EMBODIMENT

Reference will now be made in detail to a preferred embodiment of the present invention.

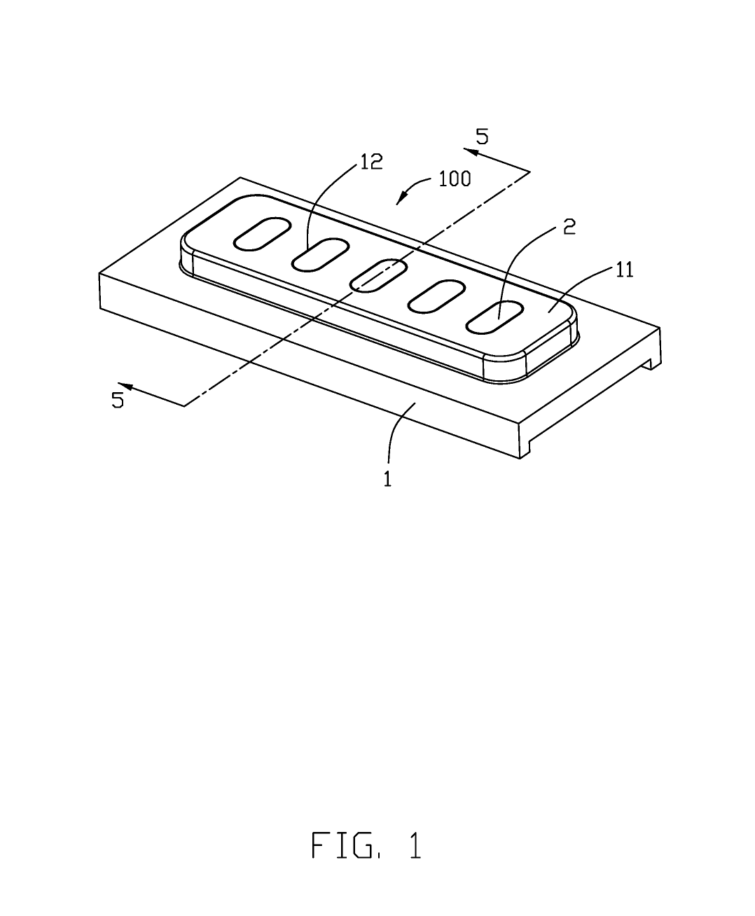

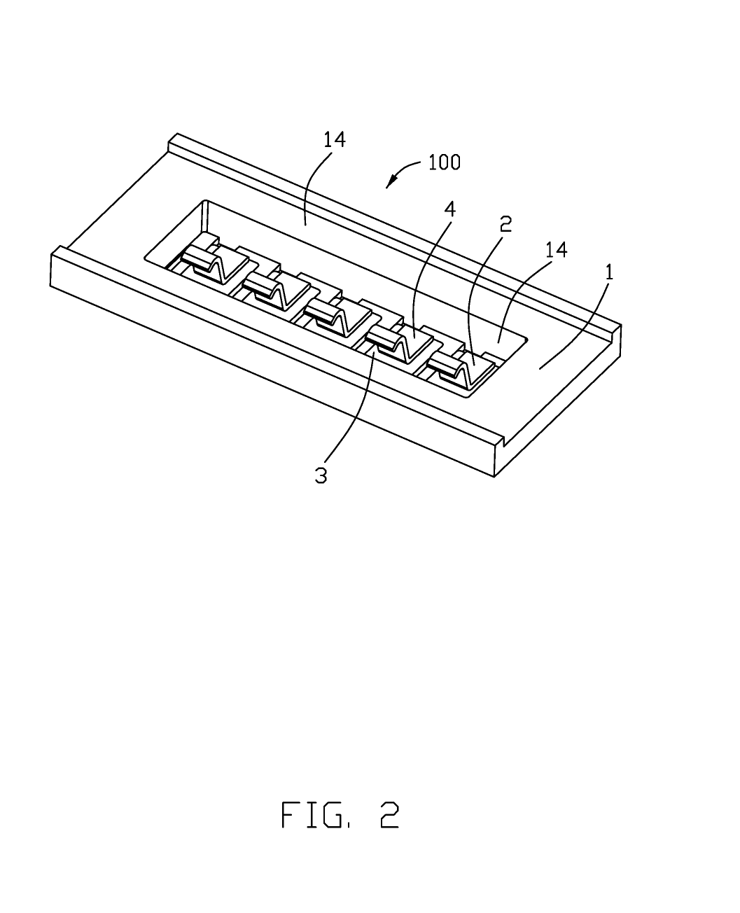

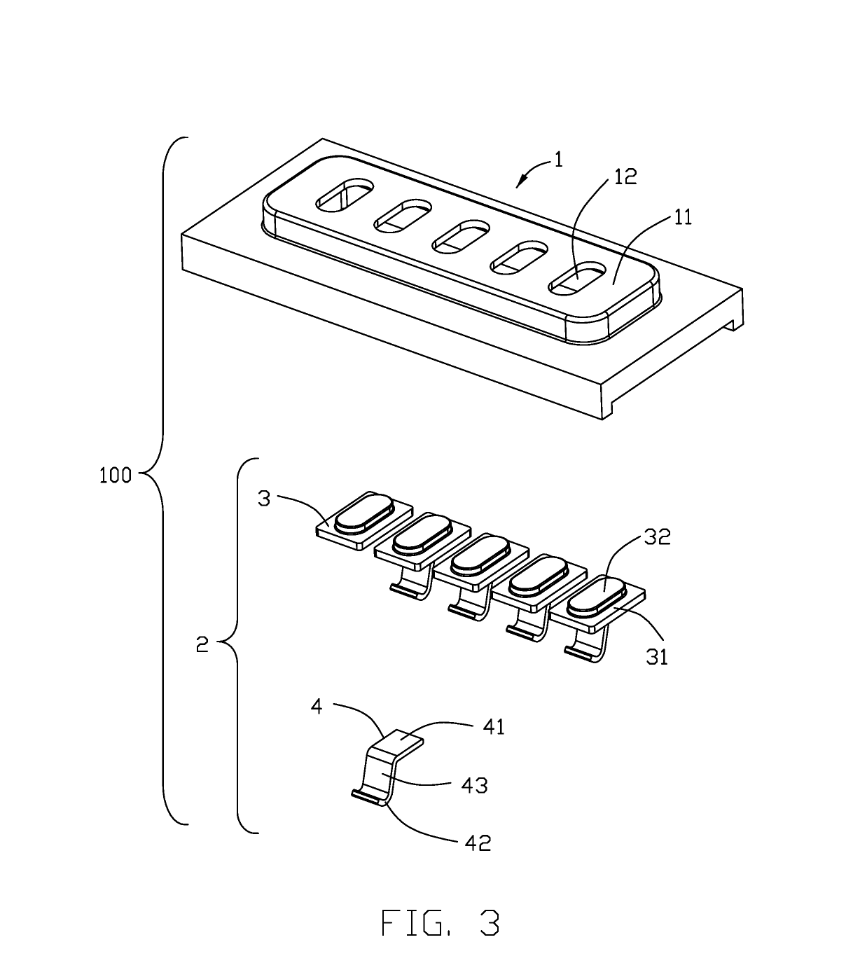

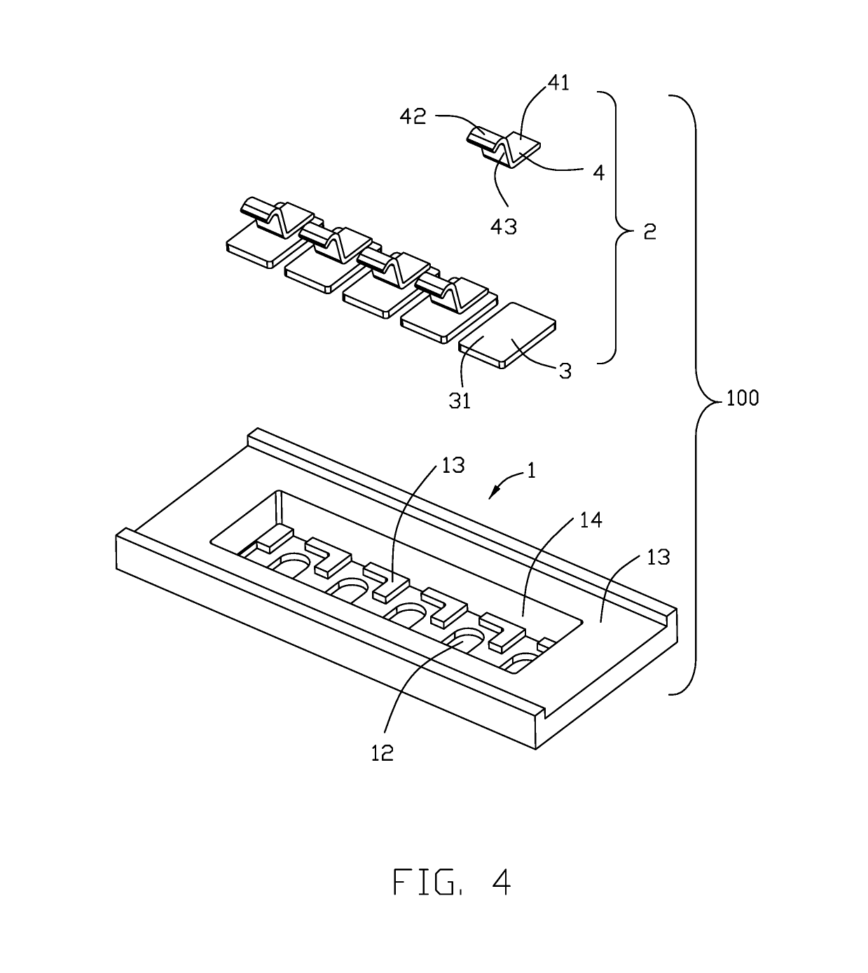

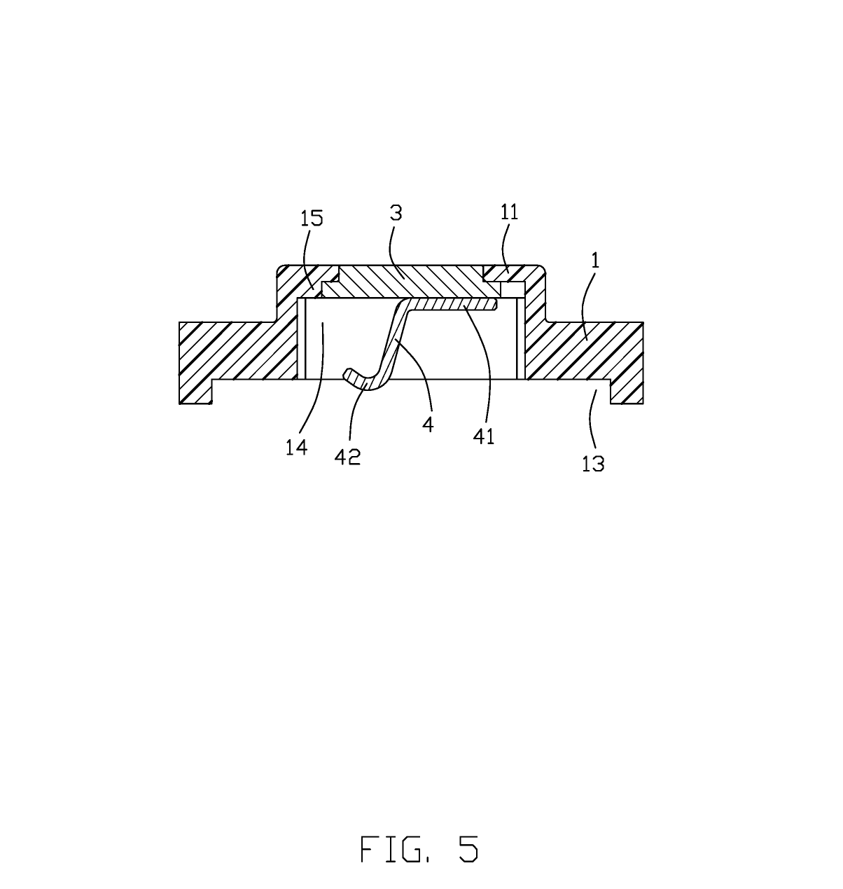

Referring to FIGS. 1 to 5, an electrical connector 100 is adapted for being electrically connected a mating connector to a printed circuit board to transmit signal, power, or signal and power. The electrical connector comprises an insulative housing 1 and a plurality of contacts 2 being over molded in the insulative housing 1. Each of the contacts 2 comprises a conductive member 3 molded in the insulative housing 1, and a connecting member 4 electrically connected with the conductive member 3 and adapted for being pressed against with the printed circuit board to establish an electrically connection therewith.

The insulative housing 1 has a rectangular shape. The insulative housing 1 comprises a main body, a receiving portion 11 projected from the main body. The first the receiving portion 11 has a diameter smaller than a diameter of the main body. The contacts 2 are molded in the receiving portion 11. The receiving portion 11 is formed a plurality through holes 12 for receiving the contacts 2 when the insulative housing is molded in the contacts 2. Each of the holes 12 has a rectangular shape in a middle portion and a half circle shape in two opposite ends of the middle portion. The insulative housing 1 defines a first recess 13 recessed from a bottom surface of the main body toward the receiving portion 11 for receiving the printed circuit board. The first recess 13 extends through the main body along a length direction. The insulative housing 1 defines a second recess 14 further recessed form the first recess 13 toward the receiving portion 11. Each of the holes 12 comprises a stepped portion 15 adjacent to the second recess that is suitable a shape of the contacts 2.

Each of the conductive members 3 comprises a base portion 31 having a flat shape, and a contact portion 32 projected from the base portion 31 to be exposed out the insulative housing 1 for being electrically connected with the mating connector. All of the contact portions 32 are disposed at a common plane. The contact portion 32 has a rectangular shape in a middle portion and a half circle shape in two opposite ends of the middle portion.

Each of the connecting member 4 comprises a soldering portion 41 having a flat shape soldered with the base portion 31, an elastic portion 42 for being elastic contacted with and electrically connected with the printed circuit board, and a connecting portion 43 connected between the soldering portion 41 and the elastic portion 42. The soldering portion 41 is parallel to the base portion 31. The connecting portion 43 extends inclined between the soldering portion 41 and the elastic portion 42. The elastic portion 42 has an arced shape. The connecting members 4 received in the second recess 14, with a portion of the elastic portion 42 extending into the first recess 13 for being electrically connected with the printed circuit board. The second recess 14 is full filled with glue to improve waterproof performance. The connecting members 4 are soldered with the conductive members 3 before or after the insulative housing 2 being over molded with the conductive members 3

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing; and
a plurality of contacts being over molded in the insulative housing, each of the contacts comprising:
a conductive member comprising a base portion and a contact portion projected from the base portion and exposed out of the insulative housing for being electrically connected with a mating connector contact; and
a connecting member electrically connected with the conductive member, the connecting member including a soldering portion soldered with the base portion, an elastic portion for connecting to a printed circuit board, and a connecting portion connected between the soldering portion and the elastic portion.

2. The electrical connector as recited in claim 1, wherein the connecting portion extends inclinedly between the soldering portion and the elastic portion.

3. The electrical connector as recited in claim 1, wherein the base portion is flat, and the soldering portion is flat and parallel to the base portion.

4. The electrical connector as recited in claim 3, wherein the elastic portion is arcuate.

5. The electrical connector as recited in claim 1, wherein the insulative housing comprises a main body and a receiving portion projected from the main body, and the contacts are molded in the receiving portion.

6. The electrical connector as recited in claim 5, wherein the insulative housing defines a first recess recessed from a bottom surface of the main body toward the receiving portion.

7. The electrical connector as recited in claim 6, wherein the insulative housing defines a second recess further recessed form the first recess toward the receiving portion, the connecting members are received in the second recess, and a portion of the elastic portion extends into the first recess.

8. The electrical connector as recited in claim 7, wherein the second recess is filled with glue.

9. The electrical connector as recited in claim 6, wherein the first recess extends through the main body along a lengthwise direction.

10. The electrical connector as recited in claim 5, wherein the receiving portion has a diameter smaller than a diameter of the main body.

11. The electrical connector as recited in claim 1, wherein the contact portions are disposed at a common plane.

12. An electrical connector comprising:
an insulative housing defining an upper mating face and a lower mounting face opposite to each other in a vertical direction; and
a plurality of contacts being over molded in the insulative housing, each of the contacts including:
a conductive member received within the housing and forming a contact portion exposed upon the upper mating face for being electrically connected with a mating connector contact; and
a connecting member discrete from the conductive member and electrically and mechanically connected with the conductive member, the connecting member including an elastic portion with a curved end extending around the lower mounting face for connecting to a printed circuit board; wherein
said conductive member is rigid while said connecting member is deflectable in the vertical direction.

13. The electrical connector as claimed in claim 12, wherein said connecting member is soldered on an underside of the conductive member.

14. The electrical connector as claimed in claim 12, wherein said conductive member includes a base portion and said contact portion protrudes upwardly from the base portion, said base portion being larger than the contact portion in a top view so as to prohibit said conductive member from being upwardly withdrawn from the housing.

15. The electrical connector as claimed in claim 14, wherein said connecting member is soldered upon an underside of the base portion.
